(19) United States
(12) Patent Application Publication
(10) Pub. No.: US 2026/0236785 A1
(43) Pub. Date: Aug. 13, 2026

(54) MULTI-AGENT REINFORCEMENT LEARNING METHOD AND APPARATUS

(71) Applicant: Electronics and Telecommunications Research Institute, Daejeon (KR)

(72) Inventors: Jeongmin YANG, Daejeon (KR); Hyun Woo Kim, Daejeon (KR); Hwa Jeon Song, Daejeon (KR); Younghwan Shin, Daejeon (KR); Byunghyun Yoo, Daejeon (KR); Euisok Chung, Daejeon (KR)

(73) Assignee: Electronics and Telecommunications Research Institute, Daejeon (KR)

(21) Appl. No.: 19/445,856

(22) Filed: Jan. 12, 2026

(30) Foreign Application Priority Data
Feb. 13, 2025 (KR) 10-2025-0018842

(51) Int. Cl. G06N 3/092; G06N 3/0455

(52) U.S. Cl. CPC G06N 3/092; G06N 3/0455

(57) ABSTRACT

Multi-agent reinforcement learning according to one exemplary embodiment of the present disclosure may comprise selecting one or more tasks from a set of tasks that can be adopted in a multi-agent environment; with respect to the selected one or more tasks, generating masking information of a plurality of agents by masking information of one or more first agents, which are some of the plurality of agents constituting the multi-agent environment, the masking information including masked information of the one or more first agents; encoding a skill latent vector using the masking information of the plurality of agents; and decoding the skill latent vector to infer actions of the plurality of agents.

### CROSS-REFERENCE TO RELATED APPLICATION

This application claims priority to Korean Patent Application No. 10-2025-0018842 filed on Feb. 13, 2025 with the Ministry of Intellectual Property Office (MOIP), the entire contents of which are hereby incorporated by reference.

### BACKGROUND

### 1. Technical Field

The present disclosure relates to an artificial intelligence technology, and more particularly, to a reinforcement learning method in a multi-agent environment.

### 2. Description of the Related Art

The content described in this section merely provides background information on the present exemplary embodiments and does not constitute prior art.

Reinforcement learning has been developed as a method in which a single agent learns an action or a policy to maximize a reward for a given task. However, in most fields in which reinforcement learning is required to be applied in practice, a plurality of agents determine actions based on respective information and policies for cooperative or competitive objectives. Reinforcement learning in such an environment is referred to as multi-agent reinforcement learning (MARL).

When MARL is approached in a fully centralized manner as in an existing single-agent reinforcement learning scheme, as the number of agents increases, all combinations of actions of all agents, that is, a joint action space, increase exponentially, and thus convergence of learning is practically impossible. Conversely, when a fully decentralized approach is applied, each agent considers only a reward of the corresponding agent, and learning of cooperative or competitive behaviors among agents becomes impossible. For this reason, by taking only advantages of the two approaches, centralized training and decentralized execution (CTDE), in which observation information of all agents is utilized in a training process while actions are determined based only on observation information of each agent in an inference process, is a general approach of MARL.

Meta-learning is a research field intended to apply to machine learning the human brain capability of rapidly adapting to and solving a new task that has not been encountered during a learning stage, and is known as a technique of “learning how to learn.” Existing deep learning networks have rapidly developed across all fields of supervised learning, unsupervised learning, and reinforcement learning, but have consistently exhibited low performance in any application field with respect to data not used for learning. In particular, in reinforcement learning, a network trained to solve a specific task has generally been required to be trained again from the beginning when the task is slightly changed, without being able to solve the problem. For example, a reinforcement learning deep learning network that has learned an escape method of a maze in which positions of an entrance and an exit are fixed has been known to have a problem in that the reinforcement learning deep learning network is unable to solve the problem or exhibits a sharply degraded performance even when the positions of the entrance or the exit are slightly changed.

Meta-learning has also been applied to reinforcement learning to address a disadvantage of existing reinforcement learning in which performance for a task not encountered during learning is degraded. In meta reinforcement learning, all of the three approaches described above are valid, and due to characteristics of reinforcement learning, a model-based scheme and a metric-based scheme are used in combination. Context-based meta reinforcement learning, which is one of such approaches, aims to increase a convergence speed in a new task by using a relationship between a previous task and a new task. From an aspect of storing a previous task or a trajectory, a model-based approach is used, and from an aspect of using correlation between tasks, a metric-based approach is used. In order to enhance generalization performance of meta reinforcement learning, a task augmentation method using a generative model or interpolation among a plurality of tasks is also used.

In multi-agent reinforcement learning, compared to existing reinforcement learning, a joint action space becomes exponentially larger, thereby requiring significantly more computation for convergence of learning, and at the same time, a problem has been known in that a convergence speed for learning a new task is remarkably slow.

### SUMMARY

The present disclosure has been derived to address problems of the conventional art, and an object of the present disclosure is to propose a technology that introduces a meta-learning element into a multi-agent reinforcement learning environment to maintain generalization performance while increasing adaptation and convergence speed for a new task, and to expand a range of solvable tasks.

Meta-learning and meta reinforcement learning have aimed to rapidly adapt to a new task that has not been encountered during a learning stage, and thus have oriented toward finding a learning point that is performance-neutral across various tasks while preventing overfitting to a specific task as much as possible. That is, an objective is to simultaneously solve two problems of maximizing generalization performance and rapidly adapting to a new task.

Such a meta-learning element has also been applied to reinforcement learning and has been developed into context-based meta reinforcement learning, etc. Context-based meta reinforcement learning adopts a methodology of defining information or a skill of a task and using the information for solving a new task as well.

An object of the present disclosure is to propose a method that introduces a masking-restoration concept of an MAE (Masked Auto-Encoder) into a skill-based technique, which is a known solution of multi-agent reinforcement learning, to increase a speed of adapting to a new task while expanding a category of tasks that can be solved by multi-agent meta reinforcement learning.

A multi-agent reinforcement learning method according to exemplary embodiments of the present disclosure for achieving the above-described purpose may comprise: selecting one or more tasks from a set of tasks that is capable of being adopted in a multi-agent environment; with respect to the selected one or more tasks, generating masking information of a plurality of agents by masking information of one or more first agents, which are a subset of the plurality of agents constituting the multi-agent environment, the masking information including masked information of the one or more first agents; encoding a skill latent vector using the masking information of the plurality of agents; and decoding the skill latent vector to infer actions of the plurality of agents.

The generating of the masking information of the plurality of agents may comprise: selecting the one or more first agents based on a predetermined probability; and masking state information of the one or more first agents.

The encoding of the skill latent vector may comprise encoding the skill latent vector using an encoder of a pre-trained variational autoencoder (VAE, Variational Autoencoder) such that a distribution of the skill latent vector satisfies a predetermined condition.

The pre-trained VAE may be pre-trained such that the distribution of the skill latent vector satisfies a uniform distribution.

The decoding of the skill latent vector to infer the actions of the plurality of agents may comprise decoding the skill latent vector using a decoder of a pre-trained variational autoencoder (VAE, Variational Autoencoder) such that the inferred actions of the plurality of agents follow actions of a reference dataset.

The multi-agent reinforcement learning method may further comprise: with respect to the selected one or more tasks, obtaining, from a reference dataset, action information corresponding to unmasked state information of the plurality of agents; and comparing the inferred actions of the plurality of agents with the action information corresponding to the unmasked state information of the plurality of agents obtained from the reference dataset.

The multi-agent reinforcement learning method may further comprise: training a variational autoencoder (VAE, Variational Autoencoder) including an encoder that encodes the skill latent vector and a decoder that decodes the skill latent vector to infer the actions of the plurality of agents, such that, with respect to the selected one or more tasks, the inferred actions of the plurality of agents follow the actions of the reference dataset.

A multi-agent reinforcement learning method according to exemplary embodiments of the present disclosure for achieving the above-described purpose may comprise: providing a pre-trained autoencoder that performs an operation of encoding a skill latent vector and then decoding the skill latent vector to infer an action in a state in which information of a subset of a plurality of agents constituting a multi-agent environment is masked; inferring a skill corresponding to actions of the plurality of agents by inputting an observation embedding into the autoencoder; calculating an agent value function based on the inferred skill; and determining actions of the plurality of agents by controlling a multi-agent reinforcement learning engine such that the agent value function satisfies a predetermined condition.

The the pre-trained autoencoder may comprise an encoder that encodes a skill latent vector in response to the observation embedding, and a decoder that decodes the skill latent vector to infer the actions of the plurality of agents, and the pre-trained autoencoder may be pre-trained with a function of inferring the actions of the plurality of agents such that actions inferred by encoding the skill latent vector in a state in which information of a subset of the plurality of agents is masked and then decoding the skill latent vector follow actions corresponding to unmasked state information of the plurality of agents in a reference dataset.

The inferring of the skill corresponding to the actions of the plurality of agents may comprise: encoding, by the encoder, the skill latent vector in response to the observation embedding; and decoding, by the decoder, the skill latent vector to infer the actions of the plurality of agents.

The multi-agent reinforcement learning method may further comprise: selecting a task that is not used for training of the pre-trained autoencoder, wherein inferring the skill corresponding to the actions of the plurality of agents comprises inferring, by inputting an observation embedding for the selected task into the pre-trained autoencoder, a skill corresponding to the actions of the plurality of agents for the selected task.

The calculating of the agent value function based on the inferred skill may comprise: calculating a value function of an individual agent based on the observation embedding and the inferred skill; and calculating the agent value function based on the value function of the individual agent and reward quantification.

A multi-agent reinforcement learning apparatus according to exemplary embodiments of the present disclosure for achieving the above-described purpose may comprise: a processor that executes one or more instructions; and a variational autoencoder (VAE, Variational Autoencoder) including an encoder and a decoder. The processor, by the one or more instructions, may select a plurality of first tasks from a set of tasks that can be adopted in a multi-agent environment, with respect to the selected plurality of first tasks, generate masking information of a plurality of agents by masking information of one or more first agents, which are a subset of the plurality of agents constituting the multi-agent environment, the masking information including masked information of the one or more first agents, control the encoder to encode a skill latent vector using the masking information of the plurality of agents, and control the decoder to decode the skill latent vector to infer actions of the plurality of agents.

The processor may select the one or more first agents based on a predetermined probability and mask state information of the one or more first agents to generate the masking information of the plurality of agents.

The processor may encode the skill latent vector using the pre-trained encoder such that a distribution of the skill latent vector satisfies a predetermined condition.

The processor may decode the skill latent vector using a pre-trained decoder such that inferred actions of the plurality of agents follow actions of a reference dataset in order to infer the actions of the plurality of agents.

The processor may obtain, from the reference dataset, action information corresponding to unmasked state information of the plurality of agents with respect to the selected one or more tasks, compare the inferred actions of the plurality of agents with the action information corresponding to the unmasked state information of the plurality of agents obtained from the reference dataset, and train the encoder and the decoder such that, with respect to the selected one or more tasks, the inferred actions of the plurality of agents follow the actions of the reference dataset.

The processor may infer a skill corresponding to the actions of the plurality of agents by inputting an observation embedding into the variational autoencoder, calculate an agent value function based on the inferred skill, and determine actions of the plurality of agents by controlling one or more of 1 a pre-trained autoencoder or 2 a multi-agent reinforcement learning engine such that the agent value function satisfies a predetermined condition.

The processor may select a second task that has not been used for pre-training of the variational autoencoder, and infers, by inputting the observation embedding for the selected second task into the pre-trained variational autoencoder, a skill corresponding to the actions of the plurality of agents for the selected second task.

The processor may calculate, in order to calculate the agent value function, a value function of an individual agent based on the observation embedding and the inferred skill, and calculate the agent value function based on the value function of the individual agent and reward quantification.

According to exemplary embodiments of the present disclosure, by introducing a meta-learning element into a multi-agent reinforcement learning environment, generalization performance can be maintained while adaptation and convergence speed for a new task are increased, and a range of solvable tasks can be expanded.

According to exemplary embodiments of the present disclosure, a learning point that is performance-neutral across various tasks can be explored while preventing overfitting to a specific task as much as possible. According to exemplary embodiments of the present disclosure, two problems of maximizing generalization performance and rapidly adapting to a new task can be simultaneously solved.

According to exemplary embodiments of the present disclosure, by introducing a masking-restoration concept of an MAE (Masked Auto-Encoder) into a skill-based technique, which is a known solution of such multi-agent reinforcement learning, a speed of adapting to a new task can be increased while expanding a category of tasks that can be solved by multi-agent meta reinforcement learning.

Meta-learning faces a challenge of simultaneously solving a problem having conflicting objectives of maximizing generalization performance while rapidly adapting to a new task. According to exemplary embodiments of the present disclosure, when performing skill-based multi-agent reinforcement learning in a situation in which learning is performed limited to predetermined tasks in a pre-training process of multi-agent reinforcement learning, a technique of masking specific agent information and restoring the masked specific agent information can be applied. According to exemplary embodiments of the present disclosure, even for a task that has not been learned in the pre-training process, a phenomenon in which a reward is degraded can be prevented and an action can be well restored.

### BRIEF DESCRIPTION OF THE DRAWINGS

In order that the disclosure may be well understood, there will now be described various forms thereof, given by way of example, reference being made to the accompanying drawings, in which:

FIG. 1 is an operational flowchart conceptually illustrating a multi-agent reinforcement learning method according to one exemplary embodiment of the present disclosure.

FIG. 2 is an operational flowchart conceptually illustrating a multi-agent reinforcement learning method using a mask auto-encoder (MAE, Masked Auto-Encoder) according to one exemplary embodiment of the present disclosure.

FIG. 3 is an operational flowchart conceptually illustrating a pre-training process using a mask auto-encoder (MAE, Masked Auto-Encoder) of a multi-agent reinforcement learning method according to one exemplary embodiment of the present disclosure.

FIG. 4 is an operational flowchart conceptually illustrating an action inference process based on multi-agent reinforcement learning using a mask auto-encoder (MAE, Masked Auto-Encoder) according to one exemplary embodiment of the present disclosure.

FIG. 5 is a conceptual diagram illustrating an MAE (Masked Auto-Encoder)-based multi-agent reinforcement learning process according to one exemplary embodiment of the present disclosure.

FIG. 6 is a conceptual diagram illustrating an offline reference dataset to which a masking technique is applied in a multi-agent reinforcement learning method according to one exemplary embodiment of the present disclosure.

FIG. 7 is a conceptual diagram illustrating a skill or action inference process using a masking technique in a multi-agent reinforcement learning method according to one exemplary embodiment of the present disclosure.

FIG. 8 is a conceptual diagram illustrating a skill or action inference process using a pre-trained MAE engine in a multi-agent reinforcement learning method according to one exemplary embodiment of the present disclosure.

FIG. 9 is a conceptual diagram illustrating an example of a generalized computing system in which an MAE-based multi-agent reinforcement learning apparatus capable of performing at least a part of the processes of FIGS. 1 to 8 is implemented.

### DETAILED DESCRIPTION

For a clearer understanding of the features and advantages of the present disclosure, exemplary embodiments of the present disclosure will be described in detail with reference to the accompanied drawings. However, it should be understood that the present disclosure may be not be limited to particular embodiments disclosed herein but comprises all modifications, equivalents, and alternatives falling within the spirit and scope of the present disclosure. In the drawings, similar or corresponding components may be designated by the same or similar reference numerals.

The terminologies including ordinals such as “first” and “second” or another identifiers such as “A” and “B” may be used to discriminate a component from the other ones but may not be intended to be limiting to a specific component. For example, a second component may be referred to as a first component and, similarly, a first component may also be referred to as a second component without departing from the scope of the present disclosure. As used herein, the term “and/or” may comprise a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies may be used herein for the purpose of describing particular exemplary embodiments only and may not be intended to limit the present disclosure. The singular forms comprise plural referents as well unless the context clearly dictates otherwise. Also, the expressions “comprises” or “comprises” may be used to refer a presence of a combination of stated features, numbers, processing steps, operations, elements, or components, but may not be intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Meanwhile, even technologies that have been publicly known prior to a filing date of the present application may be comprised as a part of configurations of the present disclosure when necessary, and in this regard, descriptions are provided in this specification within a range that does not obscure the spirit of the present disclosure. However, in describing configurations of the present disclosure, detailed descriptions of matters that are publicly known prior to the filing date of the present application and can be obviously understood by those skilled in the art may obscure the spirit of the present disclosure, and thus excessively detailed descriptions of known technologies are omitted.

However, the spirit of the present disclosure is not intended to claim rights to such known technologies, and contents of the known technologies may be comprised as a part of the present disclosure within a range that does not depart from the spirit of the present disclosure.

Hereinafter, preferred exemplary embodiments of the present disclosure will be described in more detail with reference to the accompanying drawings. In describing the present disclosure, identical reference numerals are used for identical components in the drawings to facilitate overall understanding, and duplicate descriptions of identical components are omitted.

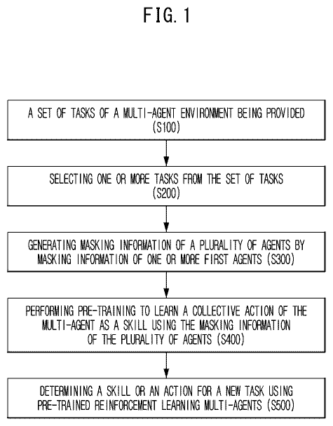

FIG. 1 is an operational flowchart conceptually illustrating a multi-agent reinforcement learning method according to one exemplary embodiment of the present disclosure.

As shown in FIG. 1, a multi-agent reinforcement learning method according to one exemplary embodiment of the present disclosure may comprise being provided a set of tasks that is able to be adopted in a multi-agent environment (step S100); selecting one or more tasks from the set of tasks (step S200); generating masking information of a plurality of agents by masking information of one or more first agents, which are a subset of the plurality of agents constituting the multi-agent environment, with respect to the selected one or more tasks, the masking information including masked information of the one or more first agents (step S300); performing pre-training to learn a collective action of the multi-agent as a skill using the masking information of the plurality of agents (step S400); and determining a skill or an action for a new task using pre-trained reinforcement learning multi-agents (step S500).

In this case, in selecting one or more tasks from the set of tasks (step S200), a randomly determined number of tasks may be selected.

For convenience of description, exemplary embodiments of the present disclosure may assume the following situations.

Since tasks of a multi-agent environment are approached in a centralized training and decentralized execution (CTDE) scheme, a state is used as information of all agents during learning, while, during inference, each agent may use only an observation collected by each agent.

A set of tasks of a multi-agent environment may be provided (step S100).

A randomly determined number of tasks may be selected from the task set (step S200), and pre-training may be performed using offline data state, action, reward, next state as a reference dataset of the tasks (step S300), (step S400).

In a pre-training stage, meaningful collective behaviors of a plurality of agents may be defined as skills and may be learned (step S400).

In a subsequent inference process, in order to solve a new task randomly selected from tasks not used for pre-training from the task set, a skill inferred by a pre-trained auto-encoder and/or a multi-agent reinforcement learning engine may be used (step S500).

In exemplary embodiments of the present disclosure, a meta-learning technique is employed. A rhetorical definition of an expression “learning how to learn” of meta-learning may comprise all methodologies for improving performance with respect to a dataset or a task that has not been used in a learning stage.

More generally, a network for meta-learning may be configured as another or higher or meta algorithm or deep learning network that assists a conventional deep learning network. Meta-learning may be classified into an optimization-based scheme, a metric-based scheme, or a model-based scheme, etc., according to an approach to problem solving.

A problem to be solved in the present disclosure is to improve low generalization performance of the conventional art as follows.

First, a problem due to shallow superficial learning may be cited.

General reinforcement learning does not understand an essence of a problem and learns superficially, and thus even for a task having the same rules and objectives, a problem may occur in which the task cannot be easily solved when a given problem is slightly modified. For example, in a maze escape task, a problem may occur in which a change in an exit position by only a small amount is recognized as a new task. Such a problem may generally be referred to as a problem due to shallow superficial learning.

Second, a problem of degradation in generalization performance due to shallow learning may be cited.

A new task and tasks used for learning may operate well for tasks having similar dimensions, particularly tasks that can be easily derived by interpolating among tasks used for learning, but when departing from the category or range, the tasks may not be easily solved.

For example, in a case of an engine trained by reinforcement learning on a 3 versus 3 action problem assuming three ally-side agents and three adversary-side agents and a 5 versus 5 action problem assuming five ally-side agents and five adversary-side agents, a 4 versus 4 situation positioned dimensionally between the two tasks may be recognized as an interpolated task of the previously learned two tasks and thus may be solvable, whereas a 7 versus 7 situation positioned outside the range may exhibit a tendency of not being easily solved.

Third, a task scalability problem may be cited.

This may refer to a problem of low scalability for cases in which tasks that have already been well solved are simply combined.

For example, in a situation in which a 3 versus 2 problem assuming three ally-side agents versus two adversary-side agents and a 5 versus 4 problem assuming five ally-side agents versus four adversary-side agents have been perfectly learned, an 8 versus 6 problem obtained by simply adding the two scenarios may be solved in a divide and conquer manner by utilizing previously learned strategies, but such an approach is not used in conventional reinforcement learning processes.

Fourth, a dataset efficiency problem and a convergence sensitivity problem may be cited.

Performance when a new task is given is generally improved as a number of pre-trained tasks increases, but since such improvement does not have a proportional relationship, dataset efficiency is low, and selection of pre-training scenarios is very important and sensitivity to performance of a reinforcement learning engine may be high.

A reinforcement learning and inference process according to exemplary embodiments of the present disclosure for solving such problems may be summarized as shown in FIG. 1.

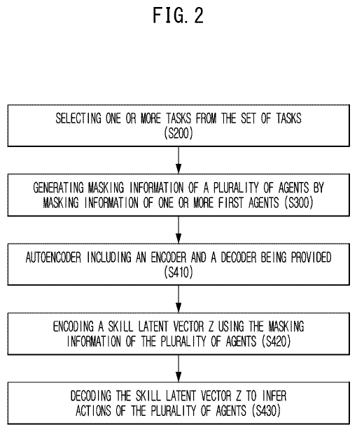

FIG. 2 is an operational flowchart conceptually illustrating a multi-agent reinforcement learning method using a mask auto-encoder (MAE) according to one exemplary embodiment of the present disclosure.

Referring to FIG. 2, a multi-agent reinforcement learning method according to one exemplary embodiment of the present disclosure may comprise selecting one or more tasks from a set of tasks that is able be adopted in a multi-agent environment (step S200); generating masking information of a plurality of agents by masking information of one or more first agents, which are a subset of the plurality of agents constituting the multi-agent environment, with respect to the selected one or more tasks, the masking information including masked information of the one or more first agents (step S300); encoding a skill latent vector z using the masking information of the plurality of agents (step S420); and decoding the skill latent vector z to infer actions of the plurality of agents (step S430).

In this case, a variational autoencoder (VAE) including an encoder and a decoder may be provided (step S410).

Generating masking information of the plurality of agents (step S300) may comprise selecting one or more first agents based on a predetermined probability; and masking state information of the one or more first agents. That is, masking information of the plurality of agents may be generated by omitting information of the first agents, which are a subset of the agents, through masking (step S300).

In encoding the skill latent vector (step S420), the skill latent vector may be encoded using an encoder of a pre-trained variational autoencoder (VAE) such that a distribution of the skill latent vector satisfies a predetermined condition.

In this case, the pre-trained variational autoencoder may be pre-trained such that the distribution of the skill latent vector satisfies a uniform distribution.

In decoding the skill latent vector to infer actions of the plurality of agents (step S430), the skill latent vector may be decoded using a decoder of a pre-trained variational autoencoder (VAE) such that inferred actions of the plurality of agents follow actions of an offline dataset as a reference dataset.

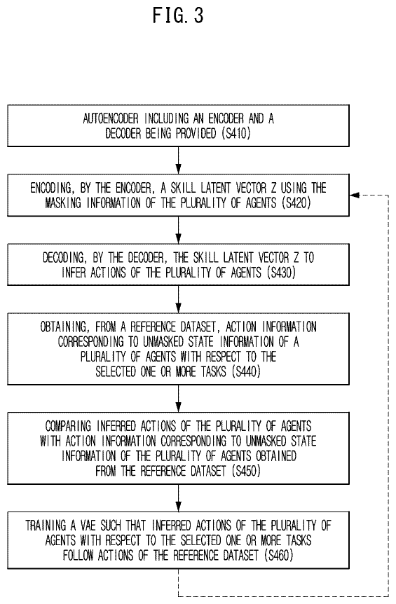

FIG. 3 is an operational flowchart conceptually illustrating a pre-training process using a mask auto-encoder (MAE) of a multi-agent reinforcement learning method according to one exemplary embodiment of the present disclosure.

In FIG. 3, descriptions of configurations overlapping with FIG. 2 are omitted.

Referring to FIG. 3, a multi-agent reinforcement learning method according to one exemplary embodiment of the present disclosure may further comprise obtaining, from a reference dataset, action information corresponding to unmasked state information of a plurality of agents with respect to the selected one or more tasks (step S440); and comparing inferred actions of the plurality of agents with action information corresponding to unmasked state information of the plurality of agents obtained from the reference dataset (step S450).

The multi-agent reinforcement learning method according to one exemplary embodiment of the present disclosure may further comprise training a variational autoencoder (VAE) including an encoder that encodes a skill latent vector and a decoder that decodes the skill latent vector to infer actions of the plurality of agents such that the inferred actions of the plurality of agents with respect to the selected one or more tasks follow actions of the reference dataset (step S460).

A VAE is an artificial neural network in which an encoder and a decoder are combined, and it is known that the VAE can be utilized for information compression and generative artificial neural networks by diversifying learning conditions according to a purpose.

In an encoding process, a latent vector may be generated through information compression and feature extraction, and in a decoding process, data restoration and generation of new data within a similar distribution may be performed.

In this case, the latent vector may be learned using, as a loss function, a KL divergence with a probability distribution of a limited dimension according to a purpose. When feature extraction and information compression are purposes, learning is mainly performed using identical data for input and output, and after learning, only the encoder may be mainly used.

When used for a generative model, a decoder is used, and based on data processing applied to the latent vector, new data images, text, etc. in a manner desired by a user may be generated.

In one exemplary embodiment of the present disclosure, context-based meta reinforcement learning may utilize information of tasks previously learned in a form of a latent vector. In this case, a process of extracting features of a task may be required, and a VAE may be used as a tool capable of achieving such a purpose.

A Masked Auto-Encoder MAE is known as a new self-supervised learning scheme proposed to efficiently learn image data. An MAE performs learning by randomly masking a subset patch of an input image and restoring masked portions based on remaining information. Through such a scheme, a model can better understand structural patterns of an image and can increase learning efficiency even with less data. Unlike existing methods, an MAE masks most of input data to increase a training speed and reduce computational resources. In particular, an MAE exhibits strong performance on a large-scale image dataset and enables effective learning even with a relatively simple structure. An MAE has demonstrated performance improvement in various visual tasks and has been particularly noted in a field of unsupervised learning.

According to exemplary embodiments of the present disclosure, the MAE concept may be applied to a VAE structure in order to use the MAE concept not for images but for restoring, predicting, and inferring actions of multiple agents for reinforcement learning. In this case, what is generated by an encoder may be a latent vector z, and what is restored may be actions of respective agents.

According to exemplary embodiments of the present disclosure, among actions of respective agents, a set of key actions appropriately selected for reinforcement learning may be defined as a skill. In this case, what is generated by the encoder may be understood as a latent vector z of the skill.

According to exemplary embodiments of the present disclosure, a process of pre-training, using an MAE technique, a VAE structure including an encoder that generates a latent vector z of a skill and a decoder that restores, predicts, or infers an action of each of a plurality of agents from the latent vector z may be adopted. In this case, a pre-trained VAE having a function of inferring skills or actions of agents may be pre-trained by the MAE technique, thereby improving generalization performance capable of solving a new task based on a learned task. In addition, based on pre-training in which an MAE is applied to the VAE structure, a range and a category of new tasks that can be solved may be expanded.

According to exemplary embodiments of the present disclosure, by pre-training a VAE structure that restores skills using an MAE concept, a phenomenon in which a reward is degraded for a task that has not been learned in a pre-training process may be prevented and an optimized action may be restored.

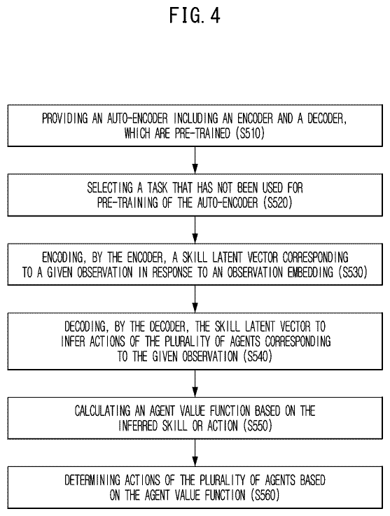

FIG. 4 is an operational flowchart conceptually illustrating an action inference process based on multi-agent reinforcement learning using a mask auto-encoder (MAE) according to one exemplary embodiment of the present disclosure.

Referring to FIG. 4, a multi-agent reinforcement learning method according to one exemplary embodiment of the present disclosure may comprise providing a pre-trained auto-encoder that performs an operation of encoding a skill latent vector and then decoding the skill latent vector to infer an action in a state in which information of a subset of a plurality of agents constituting a multi-agent environment is masked (step S510); inferring a skill corresponding to actions of the plurality of agents by inputting an observation embedding into the auto-encoder (step S530), (step S540); calculating an agent value function based on the inferred skill (step S550); and determining actions of the plurality of agents by controlling one or more of 1 a pre-trained auto-encoder or 2 a pre-trained multi-agent reinforcement learning engine such that the agent value function satisfies a predetermined condition (step S560).

In the multi-agent reinforcement learning method according to one exemplary embodiment of the present disclosure, the pre-trained auto-encoder may comprise an encoder that encodes a skill latent vector in response to an observation embedding, and a decoder that decodes the skill latent vector to infer actions of the plurality of agents.

In the multi-agent reinforcement learning method according to one exemplary embodiment of the present disclosure, the pre-trained auto-encoder may be an auto-encoder pre-trained with a function of inferring actions of the plurality of agents such that actions inferred by encoding a skill latent vector in a state in which information of a subset of the plurality of agents is masked and then decoding the skill latent vector follow actions corresponding to unmasked state information of the plurality of agents in a reference dataset.

In this case, inferring a skill corresponding to actions of the plurality of agents (step S530), (step S540) may comprise encoding, by the encoder, a skill latent vector z corresponding to a given observation in response to an observation embedding (step S530); and decoding, by the decoder, the skill latent vector z to infer actions of the plurality of agents corresponding to the given observation (step S540).

The multi-agent reinforcement learning method according to one exemplary embodiment of the present disclosure may further comprise selecting a task that has not been used for pre-training of the pre-trained auto-encoder (step S520).

In this case, in inferring a skill corresponding to actions of the plurality of agents (step S530), (step S540), by inputting an observation embedding for the selected task into the pre-trained auto-encoder, a skill corresponding to actions of the plurality of agents for the selected task may be inferred.

Calculating an agent value function based on the inferred skill (step S550) may comprise calculating a value function of an individual agent based on the observation embedding and the inferred skill; and calculating an agent value function based on the value function of the individual agent and reward quantification.

In the conventional MARL field, a method of solving a credit assignment problem using a reward quantification scheme among multiple agents may be used. In multi-agent reinforcement learning, an approach of quantifying which agent contributes to a joint reward may be used. When such quantification is appropriately performed, each agent can explore an action having a high joint action value function based on a utility function of the corresponding agent. In order to implement such reward quantification, a mixing network capable of calculating a comprehensive value function from value functions of individual agents may be introduced.

In determining actions of the plurality of agents (step S560) in one exemplary embodiment of the present disclosure, one or more of 1 the pre-trained auto-encoder or 2 the pre-trained multi-agent reinforcement learning engine may be controlled such that the agent value function satisfies a predetermined condition. In this case, the pre-trained multi-agent reinforcement learning engine may comprise a pre-trained variational autoencoder and a network in which a reward quantification function is learned.

An inference process of the reinforcement learning method according to one exemplary embodiment of the present disclosure may be performed by including deriving a skill or a skill latent vector z corresponding to a current observation using an encoder learned based on masked agent information (step S530); and converting the skill into an action using a decoder learned based on masked agent information (step S540).

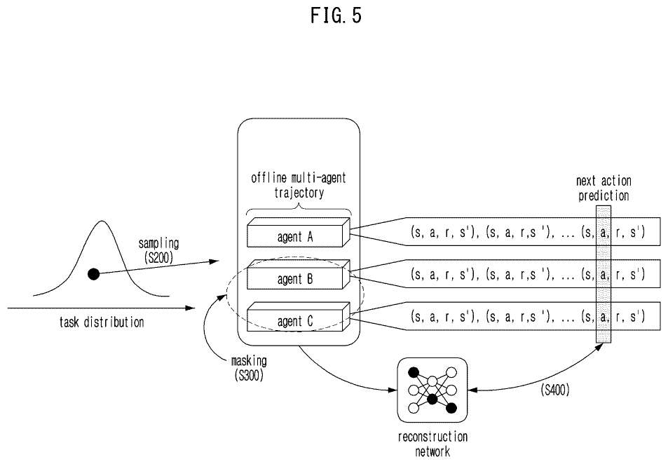

FIG. 5 is a conceptual diagram illustrating an MAE Masked Auto-Encoder-based multi-agent reinforcement learning process according to one exemplary embodiment of the present disclosure.

Referring to FIG. 5, a task for pre-training may be randomly selected from a task set (step S200).

From an offline dataset state, action of a task, a key action that frequently occurs in a specific situation may be selected as a skill. In this case, pre-training to which an MAE technique is applied to a VAE structure may be used in a step of deriving the skill.

Agent information to which the MAE technique is applied (step S300) in the offline dataset may be transmitted to a reconstruction network. In this case, the reconstruction network may have the VAE structure described above.

In the reconstruction network, an MARL policy may be learned using the skill and the offline dataset (step S400).

A task for learning may be selected from a task distribution (step S200). An offline dataset of the selected task may be referenced as a reference dataset.

When the task distribution has a total of N tasks, k tasks for learning may be randomly selected.

A trajectory of a specific task may comprise information on a state transition. For example, when a trajectory of a task is s1, a, r, s2, a process in which a state transition from a state s1 to a state s2 occurs by an action a and a reward r may be recorded.

Such extraction of a trajectory may also be performed using a known MARL pre-training model, etc.

Referring to FIG. 5, the reconstruction network may learn an inference, prediction, or restoration function for a final action.

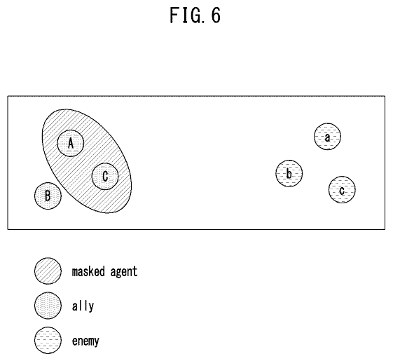

FIG. 6 is a conceptual diagram illustrating an offline reference dataset to which a masking technique is applied in a multi-agent reinforcement learning method according to one exemplary embodiment of the present disclosure.

Referring to FIG. 6, a process of selecting agents to be randomly masked is conceptually illustrated. In a situation in which ally-side agents and enemy-side agents are distributed, a process in which two ally-side agents are selected as agents to be masked is illustrated.

FIG. 6 conceptually illustrates one exemplary embodiment of the present disclosure, and it will be obviously understood by those skilled in the art that the spirit of the present disclosure is not limited to such an exemplary embodiment and various modifications are possible.

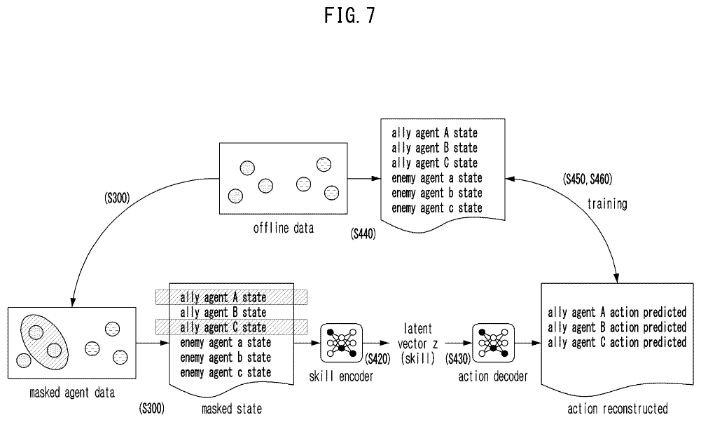

FIG. 7 is a conceptual diagram illustrating a skill or action inference process using a masking technique in a multi-agent reinforcement learning method according to one exemplary embodiment of the present disclosure.

In the exemplary embodiment of FIG. 7, a skill may refer to representing, as a latent vector, information of an action that most frequently occurs in a specific state within an offline dataset of a selected task.

In this case, the skill is a concept defined from a perspective of an entire plurality of agents rather than an action of a single agent, and by decoding such a skill latent vector into an action, actions of the plurality of agents may be determined.

In a generalized expression, the skill may be expressed as a skill or a role, etc., and when a decoder decodes an action, the expression skill may be frequently used, whereas when a reward is decoded, the expression role may be frequently used.

Masked agent data may be generated from the offline dataset (step S300). In this case, specifically, state information of selected agents may be masked.

In the exemplary embodiment of FIG. 7, masked state information may be transmitted to a skill encoder of the VAE structure. In the exemplary embodiment of FIG. 7, the skill encoder may encode a skill latent vector z (step S420). In the exemplary embodiment of FIG. 7, an action decoder of the VAE structure may reconstruct, restore, infer, or decode an action from the skill latent vector z (step S430).

Such a relationship may be expressed as Expression 1 below.

$$z = SkillEncoder ( step State ) , action = ActionDecoder ( z , observation ) \qquad [ Expression 1 ]$$

In this case, z is a skill latent vector and is an output of a Skill Encoder, and the Skill Encoder may output the skill latent vector z by using a state as an input variable.

An action of an agent is an output of an Action Decoder, and the Action Decoder may output an action by using the skill latent vector z and an observation as inputs.

When a value restored by a VAE structure is trained (step S460) to be well restored by being compared (step S450) with an unmasked action obtained from an offline dataset (step S440), the encoder can learn a function of representing a state or an observation as a most appropriate skill latent vector, and the decoder can learn a function of restoring a given skill into an action most appropriate for an environment.

According to exemplary embodiments of the present disclosure, in order to improve generalization performance of a skill, an MAE concept may be introduced into a skill learning process. According to exemplary embodiments of the present disclosure, an effect of data augmentation can be obtained by masking information of a subset agents in a process of learning a skill from selected tasks used for pre-training.

A relational expression in a pre-training exemplary embodiment of the present disclosure in which an MAE concept is applied to a VAE structure may be represented as Expression 2 below.

$$z\_masked = SkillEncoder ( masked\_state ) , action\_reconstructed = ActionDecoder ( z\_masked ) \qquad [ Expression 2 ]$$

In this case, from a masked_state in which information of a subset agents is masked, an output of the Skill Encoder is z_masked, and an output of the Action Decoder that receives z_masked as an input may be referred to as action_reconstructed.

In this case, since the VAE is trained to restore an action even in an environment in which information of a subset agents is omitted, the encoder can be more robust in a partially observable situation to which most MARL tasks belong. In addition, the decoder can improve generalization performance of decoding an action even for a scenario outside a learning range.

For example, a reinforcement learning engine trained after two ally-side agents are masked in a situation of three allies versus three adversaries can provide generalization performance for a new task similar to a case in which a situation of one ally versus three adversaries and a situation of three allies versus three adversaries are respectively learned.

Meanwhile, a VAE network according to one exemplary embodiment of the present disclosure may comprise a skill encoder and an action decoder.

In this case, the skill encoder may learn a process of encoding state→masked state→skill latent vector z. In addition, the skill encoder may be trained such that the skill latent vector z follows a uniform distribution.

An action decoder of the VAE according to exemplary embodiments of the present disclosure may learn a process of decoding skill latent vector z→action decoder→reconstructed action. In this case, the action decoder may be trained such that a restored action matches an action of an offline dataset.

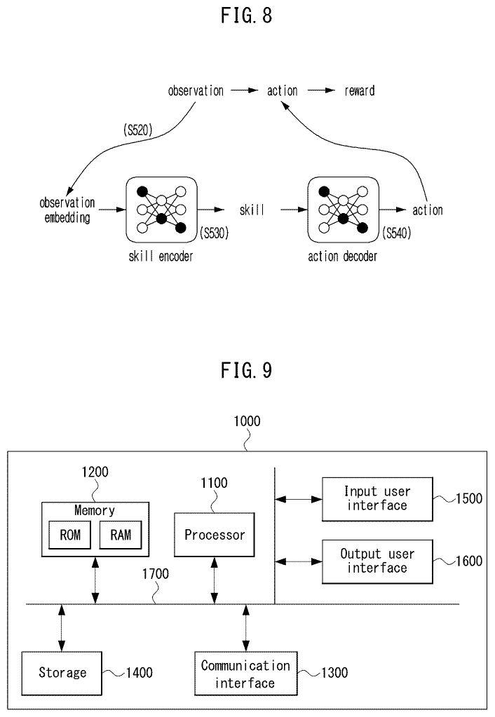

FIG. 8 is a conceptual diagram illustrating a skill or action inference process using a pre-trained MAE engine in a multi-agent reinforcement learning method according to one exemplary embodiment of the present disclosure.

In the exemplary embodiment of FIG. 8, during inference, a new task T_unseen that has not been used for pre-training may be selected and converted into an observation embedding O_unseen (step S520).

For the new task, a skill may be inferred from observation information of an agent (step S530). In this case, a derived skill latent vector z may be represented as Expression 3 below.

$$z = SkillEncoder ( O\_unseen ) \qquad [ Expression 3 ]$$

In this case, a skill most similar to a pre-trained skill may be selected. A skill may be converted into an action using an action decoder of a pre-trained VAE (step S540). In this case, a derived next action may be represented as Expression 4 below.

$$next\_action = ActionDecoder ( z , observation ) \qquad [ Expression 4 ]$$

In this case, in a skill-based MARL exemplary embodiment of the present disclosure, an agent-specific value function may be derived using an observation and a skill of each agent, and an overall value function may be derived using the agent-specific value function.

FIG. 9 is a conceptual diagram illustrating an example of a generalized computing system in which an MAE-based multi-agent reinforcement learning apparatus capable of performing at least a part of processes of FIGS. 1 to 8 is implemented.

According to one exemplary embodiment of the present disclosure, at least a part of processes of an MAE-based multi-agent reinforcement learning process, pre-training of a variational auto-encoder VAE Variational Auto-Encoder using an MAE technique, reinforcement learning using an MAE-based pre-trained VAE, and or action inference using a reinforcement-learned multi-agent may be executed by a computing system 1000 of FIG. 9.

Referring to FIG. 9, a computing system 1000 according to one exemplary embodiment of the present disclosure may comprise a processor 1100, a memory 1200, a communication interface 1300, a storage device 1400, an input interface 1500, an output interface 1600, and a bus 1700.

The computing system 1000 according to one exemplary embodiment of the present disclosure may comprise at least one processor 1100 and a memory 1200 that stores instructions instructing the at least one processor 1100 to perform at least one step. At least a part of steps of a method according to one exemplary embodiment of the present disclosure may be performed by the at least one processor 1100 loading and executing instructions from the memory 1200.

The processor 1100 may refer to a central processing unit CPU, a graphics processing unit GPU, or a dedicated processor on which methods according to exemplary embodiments of the present disclosure are performed.

Each of the memory 1200 and the storage device 1400 may be configured with one or more of a volatile storage medium and a non-volatile storage medium. For example, the memory 1200 may be configured with one or more of a read only memory ROM and a random access memory RAM.

In addition, the computing system 1000 may comprise a communication interface 1300 that performs communication through a wireless network.

In addition, the computing system 1000 may further comprise a storage device 1400, an input interface 1500, an output interface 1600, etc.

In addition, respective components comprised in the computing system 1000 may be connected by a bus 1700 and perform communication with each other.

Examples of the computing system 1000 of the present disclosure may comprise a communicable desktop computer, a laptop computer, a notebook, a smart phone, a tablet PC, a mobile phone, a smart watch, a smart glass, an e-book reader, a PMP portable multimedia player, a portable game console, a navigation device, a digital camera, a DMB digital multimedia broadcasting player, a digital audio recorder, a digital audio player, a digital video recorder, a digital video player, a PDA Personal Digital Assistant, etc.

A multi-agent reinforcement learning apparatus according to one exemplary embodiment of the present disclosure may comprise a memory 1200 that stores one or more computer-readable instructions, and a processor 1100 that executes the one or more instructions, and may further comprise a variational autoencoder (VAE) including an encoder and a decoder.

In the multi-agent reinforcement learning apparatus according to one exemplary embodiment of the present disclosure, the processor 1100 can select a plurality of first tasks from a set of tasks that can be adopted in a multi-agent environment by one or more instructions, can generate masking information of a plurality of agents by masking information of one or more first agents, which are a subset of the plurality of agents constituting the multi-agent environment, with respect to the selected plurality of first tasks, the masking information including masked information of the one or more first agents, can control the encoder to encode a skill latent vector using the masking information of the plurality of agents, and can control the decoder to decode the skill latent vector to infer actions of the plurality of agents.

The processor 1100 can select one or more first agents based on a predetermined probability in order to generate masking information of the plurality of agents, and can mask state information of the one or more first agents.

The processor 1100 can encode the skill latent vector using a pre-trained encoder such that a distribution of the skill latent vector satisfies a predetermined condition in order to encode the skill latent vector.

The processor 1100 can decode the skill latent vector using a pre-trained decoder such that inferred actions of the plurality of agents follow actions of a reference dataset in order to infer actions of the plurality of agents.

The processor 1100 can obtain, from the reference dataset, action information corresponding to unmasked state information of the plurality of agents with respect to the selected one or more tasks, can compare inferred actions of the plurality of agents with action information corresponding to unmasked state information of the plurality of agents obtained from the reference dataset, and can train the encoder and the decoder such that inferred actions of the plurality of agents with respect to the selected one or more tasks follow actions of the reference dataset.

The processor 1100 can infer a skill corresponding to actions of the plurality of agents by inputting an observation embedding into a variational autoencoder, can calculate an agent value function based on the inferred skill, and can determine actions of the plurality of agents by controlling one or more of 1 a pre-trained autoencoder or 2 a multi-agent reinforcement learning engine such that the agent value function satisfies a predetermined condition.

The processor 1100 can select a second task that has not been used for pre-training of the variational autoencoder, and can infer a skill corresponding to actions of the plurality of agents for the selected second task by inputting an observation embedding for the selected second task into the pre-trained variational autoencoder.

The processor 1100 can calculate a value function of an individual agent based on an observation embedding and an inferred skill in order to calculate an agent value function, and can calculate the agent value function based on the value function of the individual agent and reward quantification.

Operations of a method according to exemplary embodiments of the present disclosure can be implemented as a computer-readable program or code in a computer-readable recording medium. A computer-readable recording medium comprises all types of recording devices in which information readable by a computer system is stored. In addition, a computer-readable recording medium can be distributed in a network-connected computer system, and computer-readable programs or codes can be stored and executed in a distributed manner.

In addition, a computer-readable recording medium may comprise a hardware device specially configured to store and execute program instructions, such as a ROM, a RAM, a flash memory, etc. Program instructions comprise not only machine language code created by a compiler but also high-level language code that can be executed by a computer using an interpreter, etc.

Although a subset aspects of the present disclosure have been described in the context of an apparatus, the description may also represent a description according to a corresponding method, and blocks or devices correspond to method steps or features of method steps. Similarly, aspects described in the context of a method may also be represented as corresponding blocks or items or features of a corresponding apparatus. A subset or all of method steps may be performed by or using a hardware device such as a microprocessor, a programmable computer, or an electronic circuit. In some exemplary embodiments, at least one or more of most important method steps may be performed by such a device.

In exemplary embodiments, a programmable logic device, for example, a field-programmable gate array, may be used to perform some or all of functions of the methods described herein. In exemplary embodiments, a field-programmable gate array may operate together with a microprocessor to perform one of the methods described herein. In general, the methods are preferably performed by any hardware device.

Although preferred exemplary embodiments of the present disclosure have been described above with reference to the exemplary embodiments, those skilled in the art will understand that various modifications and changes can be made to the present disclosure without departing from the spirit and scope of the present disclosure set forth in the following claims.

What is claimed is:

1. A multi-agent reinforcement learning method comprising:
selecting one or more tasks from a set of tasks that is capable of being adopted in a multi-agent environment;
with respect to the selected one or more tasks, generating masking information of a plurality of agents by masking information of one or more first agents, which are a subset of the plurality of agents constituting the multi-agent environment, the masking information including masked information of the one or more first agents;
encoding a skill latent vector using the masking information of the plurality of agents; and
decoding the skill latent vector to infer actions of the plurality of agents.

2. The multi-agent reinforcement learning method of claim 1, wherein the generating of the masking information of the plurality of agents comprises:
selecting the one or more first agents based on a predetermined probability; and
masking state information of the one or more first agents.

3. The multi-agent reinforcement learning method of claim 1, wherein the encoding of the skill latent vector comprises encoding the skill latent vector using an encoder of a pre-trained variational autoencoder (VAE, Variational Autoencoder) such that a distribution of the skill latent vector satisfies a predetermined condition.

4. The multi-agent reinforcement learning method of claim 3, wherein the pre-trained VAE is pre-trained such that the distribution of the skill latent vector satisfies a uniform distribution.

5. The multi-agent reinforcement learning method of claim 1, wherein the decoding o the skill latent vector to infer the actions of the plurality of agents comprises decoding the skill latent vector using a decoder of a pre-trained variational autoencoder (VAE, Variational Autoencoder) such that the inferred actions of the plurality of agents follow actions of a reference dataset.

6. The multi-agent reinforcement learning method of claim 1, further comprising:
with respect to the selected one or more tasks, obtaining, from a reference dataset, action information corresponding to unmasked state information of the plurality of agents; and
comparing the inferred actions of the plurality of agents with the action information corresponding to the unmasked state information of the plurality of agents obtained from the reference dataset.

7. The multi-agent reinforcement learning method of claim 6, further comprising:
training a variational autoencoder (VAE, Variational Autoencoder) including an encoder that encodes the skill latent vector and a decoder that decodes the skill latent vector to infer the actions of the plurality of agents, such that, with respect to the selected one or more tasks, the inferred actions of the plurality of agents follow the actions of the reference dataset.

8. A multi-agent reinforcement learning method comprising:
providing a pre-trained autoencoder that performs an operation of encoding a skill latent vector and then decoding the skill latent vector to infer an action in a state in which information of a subset of a plurality of agents constituting a multi-agent environment is masked;
inferring a skill corresponding to actions of the plurality of agents by inputting an observation embedding into the autoencoder;
calculating an agent value function based on the inferred skill; and
determining actions of the plurality of agents by controlling a multi-agent reinforcement learning engine such that the agent value function satisfies a predetermined condition.

9. The multi-agent reinforcement learning method of claim 8, wherein the pre-trained autoencoder comprises an encoder that encodes a skill latent vector in response to the observation embedding, and a decoder that decodes the skill latent vector to infer the actions of the plurality of agents, and
wherein the pre-trained autoencoder is pre-trained with a function of inferring the actions of the plurality of agents such that actions inferred by encoding the skill latent vector in a state in which information of a subset of the plurality of agents is masked and then decoding the skill latent vector follow actions corresponding to unmasked state information of the plurality of agents in a reference dataset.

10. The multi-agent reinforcement learning method of claim 9, wherein the inferring of the skill corresponding to the actions of the plurality of agents comprises:
encoding, by the encoder, the skill latent vector in response to the observation embedding; and
decoding, by the decoder, the skill latent vector to infer the actions of the plurality of agents;

11. The multi-agent reinforcement learning method of claim 8, further comprising:
selecting a task that is not used for training of the pre-trained autoencoder, wherein inferring the skill corresponding to the actions of the plurality of agents comprises inferring, by inputting an observation embedding for the selected task into the pre-trained autoencoder, a skill corresponding to the actions of the plurality of agents for the selected task.

12. The multi-agent reinforcement learning method of claim 8, wherein the calculating of the agent value function based on the inferred skill comprises:
calculating a value function of an individual agent based on the observation embedding and the inferred skill; and
calculating the agent value function based on the value function of the individual agent and reward quantification.

13. A multi-agent reinforcement learning apparatus comprising:
a processor that executes one or more instructions; and
a variational autoencoder (VAE, Variational Autoencoder) including an encoder and a decoder,
wherein the processor, by the one or more instructions,
selects a plurality of first tasks from a set of tasks that can be adopted in a multi-agent environment,
with respect to the selected plurality of first tasks, generates masking information of a plurality of agents by masking information of one or more first agents, which are a subset of the plurality of agents constituting the multi-agent environment, the masking information including masked information of the one or more first agents,
controls the encoder to encode a skill latent vector using the masking information of the plurality of agents, and
controls the decoder to decode the skill latent vector to infer actions of the plurality of agents.

14. The multi-agent reinforcement learning apparatus of claim 13, wherein the processor selects the one or more first agents based on a predetermined probability and masks state information of the one or more first agents to generate the masking information of the plurality of agents.

15. The multi-agent reinforcement learning apparatus of claim 13, wherein the processor encodes the skill latent vector using the pre-trained encoder such that a distribution of the skill latent vector satisfies a predetermined condition.

16. The multi-agent reinforcement learning apparatus of claim 13, wherein the processor decodes the skill latent vector using a pre-trained decoder such that inferred actions of the plurality of agents follow actions of a reference dataset in order to infer the actions of the plurality of agents.

17. The multi-agent reinforcement learning apparatus of claim 13, wherein the processor obtains, from the reference dataset, action information corresponding to unmasked state information of the plurality of agents with respect to the selected one or more tasks,
compares the inferred actions of the plurality of agents with the action information corresponding to the unmasked state information of the plurality of agents obtained from the reference dataset, and
trains the encoder and the decoder such that, with respect to the selected one or more tasks, the inferred actions of the plurality of agents follow the actions of the reference dataset.

18. The multi-agent reinforcement learning apparatus of claim 13, wherein the processor infers a skill corresponding to the actions of the plurality of agents by inputting an observation embedding into the variational autoencoder,
calculates an agent value function based on the inferred skill, and
determines actions of the plurality of agents by controlling one or more of 1 a pre-trained autoencoder or 2 a multi-agent reinforcement learning engine such that the agent value function satisfies a predetermined condition.

19. The multi-agent reinforcement learning apparatus of claim 18, wherein the processor selects a second task that has not been used for pre-training of the variational autoencoder, and infers, by inputting the observation embedding for the selected second task into the pre-trained variational autoencoder, a skill corresponding to the actions of the plurality of agents for the selected second task.

20. The multi-agent reinforcement learning apparatus of claim 18, wherein the processor calculates, in order to calculate the agent value function, a value function of an individual agent based on the observation embedding and the inferred skill, and calculates the agent value function based on the value function of the individual agent and reward quantification.
